(19) United States
(12) Patent Application Publication
(10) Pub. No.: US 2016/0111031 A1
(43) Pub. Date: Apr. 21, 2016

(54) PORTABLE PRESENTATION AND/OR DISPLAY APPARATUS

(71) Applicants: Benjamin G Cikanek, Montclair, NJ (US); Michael Klar, South Orange, NJ (US)

(72) Inventors: Benjamin G Cikanek, Montclair, NJ (US); Michael Klar, South Orange, NJ (US)

(21) Appl. No.: 14/885,473

(22) Filed: Oct. 16, 2015

Related U.S. Application Data
(60) Provisional application No. 62/064,656, filed on Oct. 16, 2014.

(51) Int. Cl. G09F 15/00

(52) U.S. Cl. CPC G09F 15/0062; G09F 15/0037

(57) ABSTRACT

A lightweight, dry erase board structure assembly includes a set of dry erase boards, legs and feet. The boards have central foam board core coated on one side with a dry erase surface and a pre-applied adhesive material on the uncoated side. The dry erase boards are attached to two support legs. The legs are reinforced with custom cut feet with a pre-applied adhesive material.

### BACKGROUND

1. Technical Field

The present disclosure relates to a display apparatus, and more particularly, relates to a lightweight transportable display apparatus which can be readily assembled at the presentation site in minimal time and subsequently discarded after a predefined number of uses.

2. Background of Related Art

Dry Erase boards, or white boards, have become standard learning aids in schools, offices and other learning environments. Often times they are used to record ideas and solve problems. However, they are typically built into walls or are ridged structures that are not easily transported.

In many environments, providing writing and work walls may not be feasible due to cost, storage or logistical constraints. There is a need for a structure that can be easily and economically shipped, constructed and moved that will provide learning and collaboration around dry erase walls.

U.S. Pat. No. 20020009703 A1 discloses a portable writing surface. This unit has a carrying case that holds a double sided dry erase board with a foam board center. Although this unit uses dry erase foam board, it is restricted to needing a wall or alternative surface for support. U.S. Pat. No. 20090079136 A1 discloses a portable target stand system. U.S. Pat. No. 8,539,889 B1 discloses a portable table.

### SUMMARY

As further detailed in the description that follows, the display apparatus and system solves the aforementioned problems associated with prior art devices. Two lightweight display apparatuses, e.g., in this embodiment, in the form of dry erase boards each have a central foam board coated with a dry erase surface on one side and two or more pre-applied adhesive strips on the back which will attach to two base legs of cardboard or an alternative lightweight material. Attached to the bottom of each leg with a pre-applied adhesive is a custom-cut foot designed to provide support as well as interlock with other feet to join multiple walls together.

In accordance with one embodiment, a display system includes at least one display apparatus. The display apparatus includes a display board having a writable surface, first and second support legs adapted to convert from a first folded condition to a second open condition, and being attachable to the display board when in the second open condition thereof, and first and second foot units for attaching to the respective first and second support legs.

The apparatus may include first and second display boards with each of the first and second display boards having the writable surface. The first and second support legs may be configured for attachment to each of the first and second display boards such that the writable surface of each of the first and second display boards faces outwardly away from the first and second support legs. The first and second support legs may each define a plurality of longitudinal panels separated by longitudinal fold lines extending substantially along respective lengths of the first and second support legs. The panels of the first and second support legs are foldable along the fold lines to assume the second open condition. The display board may include adhesive strips for attaching the first and second support legs to the display board. In one embodiment, the display may include two pairs of adhesive strips with a first pair being positioned adjacent a first edge of the display board for securing the first support leg and a second pair being positioned adjacent a second side edge of the display board for securing the second leg.

The first and second foot units each may include a lower foot segment and an upper foot segment. The lower foot segment defines an outer curved surface and the upper foot segment defines a generally corresponding dimensioned inner curved surface. The first and second support legs each may also include a vertical mounting segment disposed between the upper and lower foot segments. The vertical mounting segment is attachable to the first and second support legs. Each of the first and second foot units may be substantially planar. The vertical mounting segments of the first and second foot units may include adhesive strips for attaching the first and second foot units to the first and second support legs. In one embodiment, the vertical mounting segments of the first and second foot units each define a width, which generally approximates a corresponding width of a respective panel of the first and second leg units to which the vertical mounting segments are attached.

In one aspect, the display system includes first and second display apparatuses. The first and second display apparatuses are positionable in side by side relation whereby the lower foot segment of one of the first and second foot units of the first display apparatus is positionable beneath the upper foot segment of one of the first and second foot units of the second display apparatus to couple the first and second display apparatuses.

The display system may include an outer package for storing the display board, the foot units and the first and second support legs in the folded condition.

In an embodiment, a method for assembling a display apparatus is provided. The method includes:

providing a display apparatus including two display boards each having a writing surface, first and second support legs in a folded condition and first and second foot units;

transitioning the first and second support legs to an open condition by folding panels of each of the first and second support legs along respective fold lines;

mounting the first and second support legs when in the open condition to the first and second display boards; and

attaching the first and second foot units to the first and second support legs, respectively.

The method may include securing the first and second support legs in the open condition. Mounting the first and second support legs may include attaching the first and second support legs to adhesive strips of each of the first and second display boards. Attaching the first and second foot units may include securing the first and second support legs to adhesive strips of each of the first and second foot units.

The foregoing paragraph has served as a general introduction and is not intended to limit the scope of the successive claims. Various advantages of this invention will become apparent to those engaged in the activities.

### BRIEF DESCRIPTION OF THE DRAWINGS

Preferred embodiments of the disclosure will be readily appreciated by reference to the drawings wherein:

FIG. 1 illustrates a display system in accordance with the principles of the present disclosure illustrating two display apparatuses in side by side relation with each display apparatus including two display boards, first and second attachable support legs and first and second attachable foot units;

FIG. 2 is a perspective view of a front side of a display board of the system of FIG. 1;

FIG. 3 is a perspective view of a rear side of a display board of the system of FIG. 1;

FIG. 4 is a plan view of one of the support legs in a folded stored condition;

FIG. 5 is a plan view of the support leg of FIG. 4 in an open condition;

FIG. 6 is a partial perspective view of one end of a support leg in an open condition illustrating the flaps for securing the support leg in the open condition;

FIGS. 7-8 are front and rear plan views of one of the foot units of the system of FIG. 1;

FIG. 9 is an axial view of the foot unit;

FIG. 10 is view illustrating a package containing one display apparatus;

FIGS. 11A-11C are views illustrating a sequence of transitioning the support leg from a closed condition to an open condition;

FIGS. 12-13 illustrate a sequence of assembly the display apparatus; and

FIG. 14 is a view of two display apparatuses in nested side-by-side relation thereby forming a display system.

### DETAILED DESCRIPTION

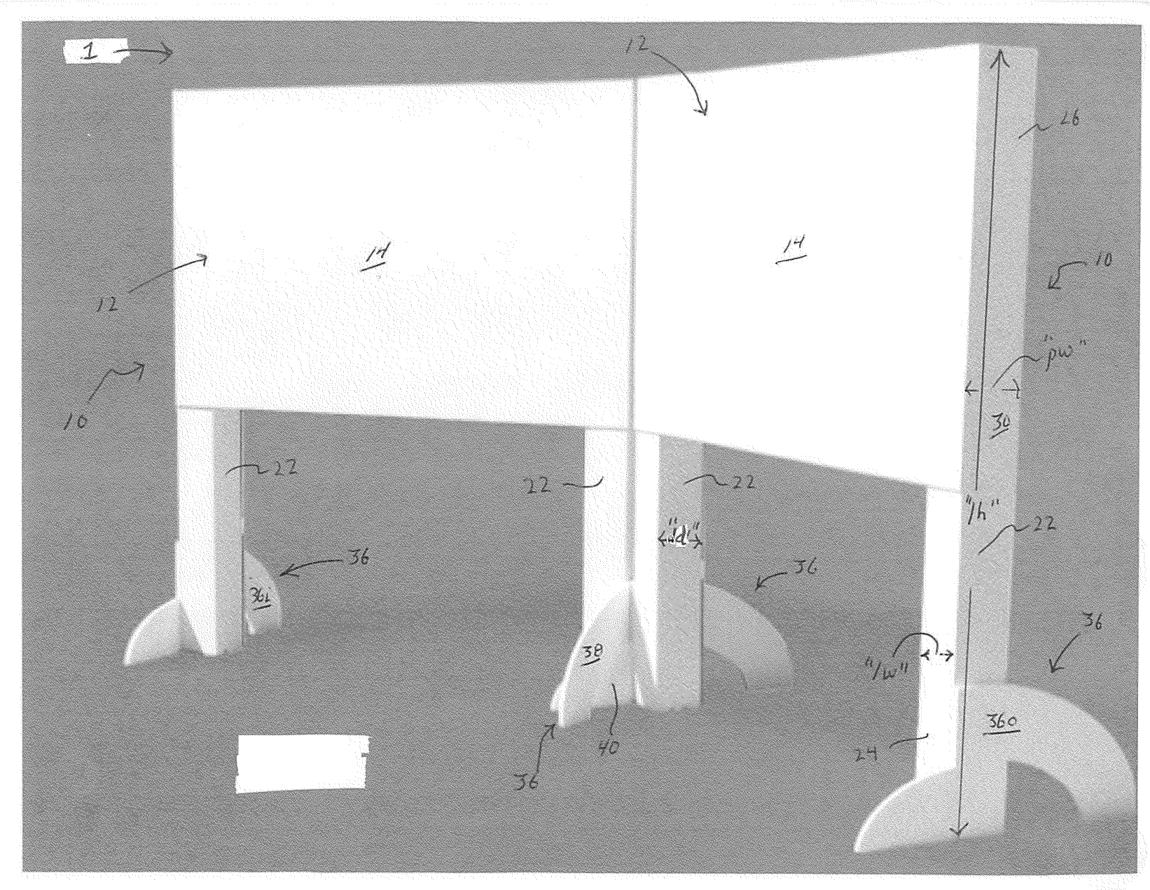

Referring now to FIG. 1, there is illustrated an apparatus and associated display system in accordance with the principles of the present disclosure. The system 1 includes one or more display apparatuses 10, two are shown, each in the form of, e.g., a display device, white board or dry erase structure. The system 1 may include a plurality of display apparatuses 10 which may be interconnected or coupled to define an array of displays for viewing by one or more subjects. Each apparatus 10 is lightweight, fully transportable and fabricated from inexpensive materials, and may be configured for assembly and use without tools at the presentation site. The apparatus 10 possesses sufficient supportive capacity to be reused for subsequent presentations or brainstorming, or may be disposable after a single use.

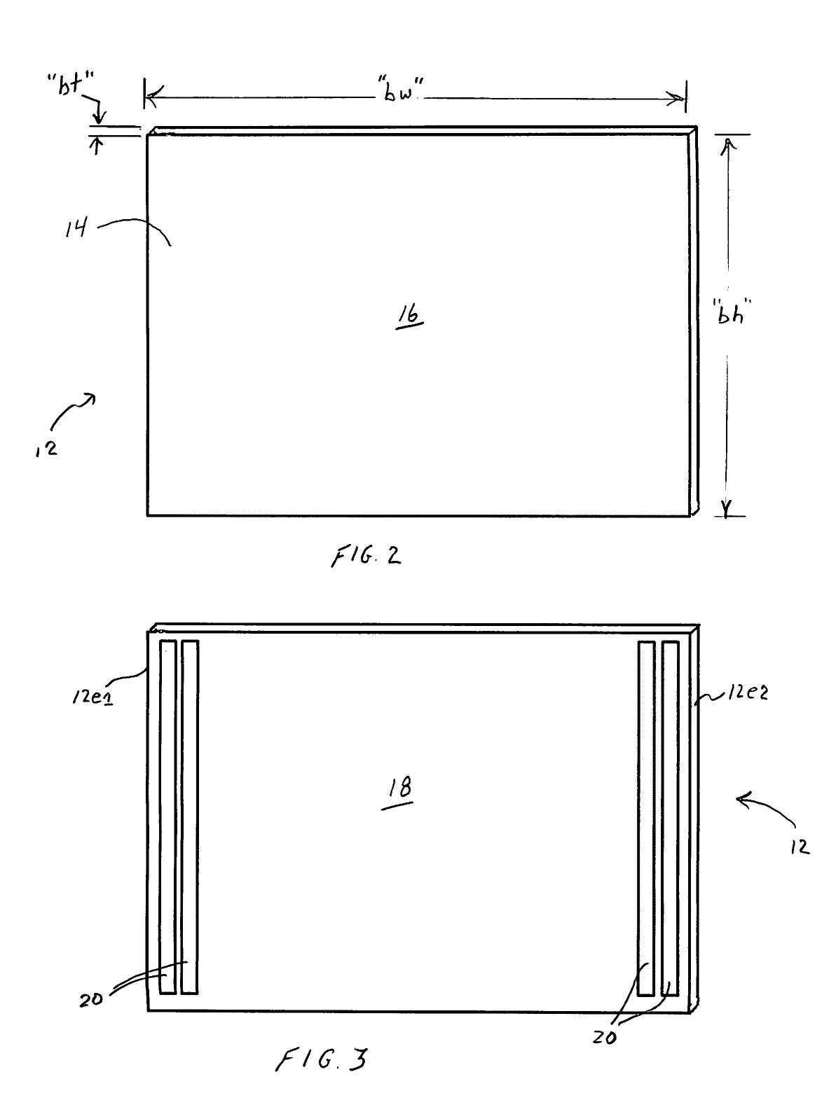

With reference to FIGS. 2-3, in conjunction with FIG. 1, each apparatus 10 of the system 1 includes one or more wall display boards or dry erase boards 12 each with a front side 14 (FIG. 2) having a writable surface 16. The writable surface 16 faces outwardly when the apparatus 10 is assembled. The writable surface 16 may include, e.g., a dry erase finish applied to the display board. The rear side 18 of the display board 12 may be devoid of a writable surface coating. The rear side (FIG. 3) of the display board 12 includes two pairs of generally linear adhesive strips 20 extending along the height of the board 12. Each pair of the adhesive strips 20 is positioned adjacent a respective edge 12e1, 12e2 of the board 12. The adhesive strips 20 include a layer of adhesive material with a releasable backing layer enclosing the adhesive material. Any conventional adhesive material may be used. It is envisioned that more or less than two adhesive strip may be utilized adjacent each side edge 12e1, 12e2 of the display board.

In the illustrated embodiment, the apparatus 10 includes two display boards 12, one on the front and back sides, respectively, of the apparatus. The display board 12 is preferably made of a material to maintain lightweight and enhance portability. In one embodiment, the display board 12 is made of a light-weight foam material with a dry erase surface applied. Alternatively, the display board 12 can be made of another material, such as cardboard, sufficient to maintain a lightweight and firm writing surface, with a dry erase coating on the outward facing side. Other suitable materials of fabrication include Sintra® or Gatorfoam®.

As indicated above, the display board 12 can be any size or style. In the illustrated embodiment, the display board 12 has a height “bh” ranging from about 30 to 50 inches, e.g., about 40 inches. In the illustrated embodiment, the display board 12 has a width “bw” of about 50 to 70 inches, preferably about 60 inches. Other height and width dimensions are also contemplated. In the illustrated embodiment, the display board 12 has a thickness “bt” (Attachment G), of approximately 0.1875 inches. In another embodiment, the display board 12 can have a thickness “bt” more or less than 0.1875 inches. The display board 12 may be relatively thin or planar in configuration.

With continued reference to FIG. 1, the display board 12 is mounted on two substantially identical support legs 22. The support legs 22 are preferably made of material sufficient to support the two display boards 12 while maintaining the structure's lightweight and portability capabilities. In one embodiment, the support legs 22 are made of cardboard. Alternatively, the support legs 22 can be made of other materials, such as, for example, plastic, foam board or PVC sufficient to support both display boards 12. The support legs 22 are configured to provide support to the display board 12. In the illustrated embodiment, the support leg 22 may have a height “lh” ranging from about 66 inches to about 78 inches, preferably about 72 and a width and depth, “lw”, “ld”, respectively each ranging from about 4 to 6 inches, preferably about 5 inches. In one embodiment, the support legs 22 define a square dimension where the width “lw” and depth “ld” is the same dimension. Other dimensions are also contemplated depending on the intended use of the structure 10. For example, the support legs 22 may be triangular, rectangular or other shapes in cross-section.

Each support leg 22 defines a first or lower base end segment 24 and a second or upper end segment 26. The display boards 12 are secured adjacent the upper end segments 26. As best depicted in FIGS. 4-5, prior to assembly, the support leg 22 is preferably flat-packed, stored, and shipped to facilitate economical shipping. In particular, and as will be discussed in greater detail hereinbelow, each support leg 22 is stored in a flat folded condition along, e.g., its midline “22m” as depicted in FIG. 4, and, thereafter, during assembly of the apparatus 10, unfolded to the flat condition depicted in FIG. 5. Once unfolded, the support legs 22 are expanded or folded along respective longitudinal fold or score lines 28 to open the longitudinal panels 30 of the support legs 22 and achieve the open expanded supportive condition of FIG. 1.

Referring now to FIG. 6, in conjunction with FIGS. 4-5, at each end of the support legs 22 is a closure mechanism including a top flap 32 and two side flaps 34. The flaps 32, 34 are folded in the direction of directional arrows d1, d2, d3 to enclose the respective upper and lower opening of the support leg 22 to thereby secure the support legs 22 in the expanded condition. The top flap 32 may include subpanel 32a which bends to fit underneath panel 30a of the support leg 22.

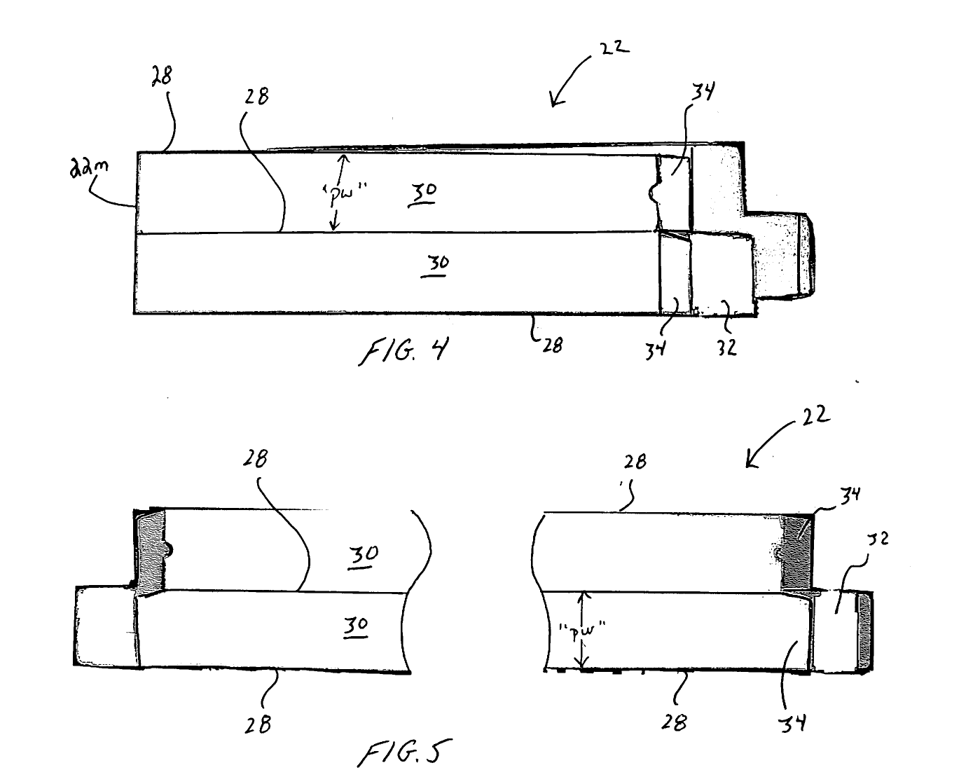

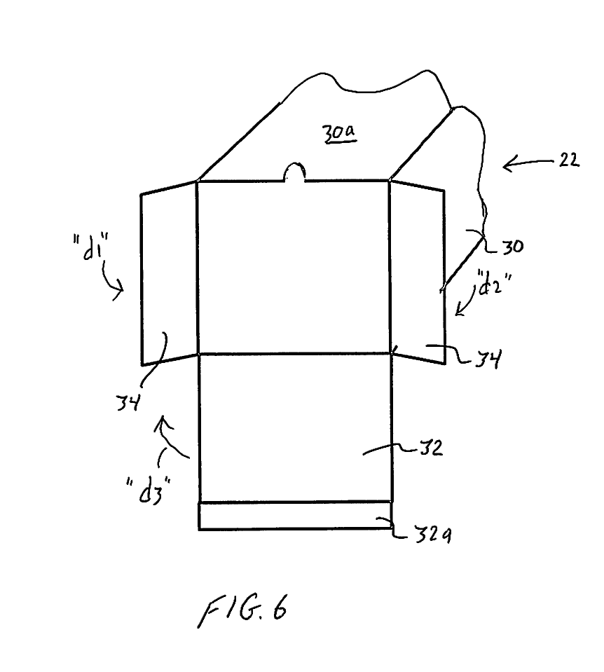

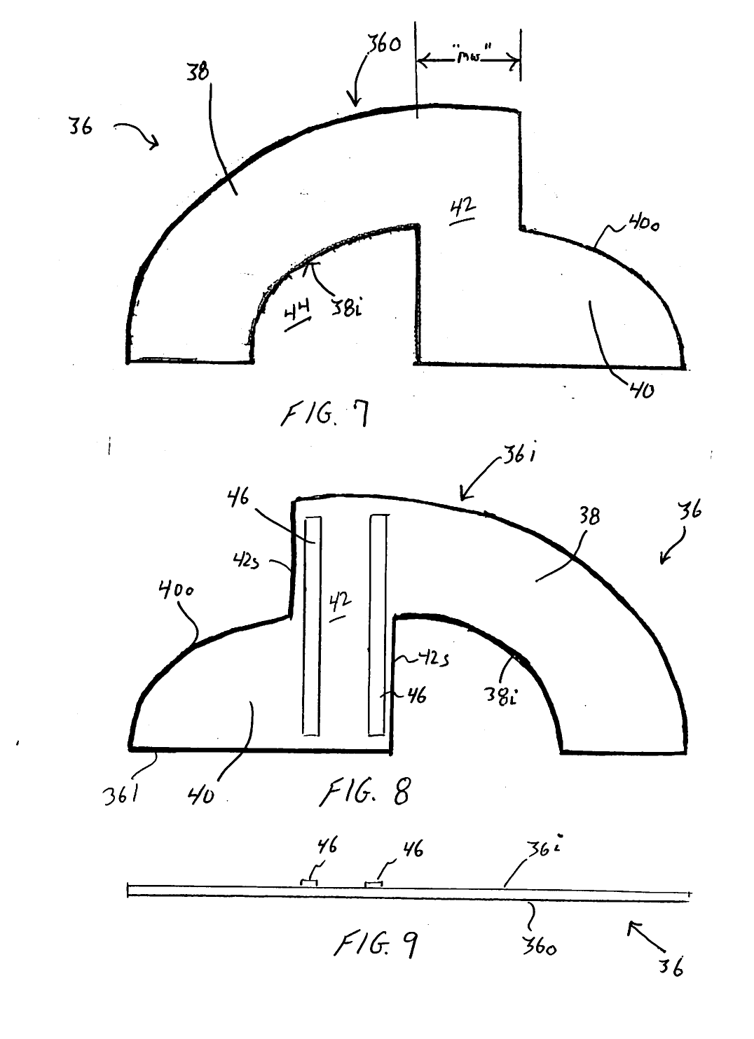

With reference to FIGS. 7-9, in conjunction with FIG. 1, the support legs 22 each have a support foot or foot unit 36 which is couplable or attachable to the support legs 22. FIG. 7 depicts the outer side 36o of the foot unit 36 facing outwardly relative to the display apparatus and FIG. 8 depicts the inner side 36i of the foot unit 36 which is attached to the support leg 22. In one embodiment, each foot unit 36 is secured to the lower base end segment 24 of the respective support leg 22. Each foot unit 36 may be a single planar monolithic piece incorporating upper and lower diametrically opposing foot segments 38, 40 which are interconnected by vertical mounting segment 42. The upper and lower foot segments 38, 40 are dimensioned to support the apparatus 10 and accommodate any loads including lateral, vertical etc. imparted on the apparatus 10 by the subject during use. Various heights of the upper and lower foot segments 38, 40 are envisioned.

The upper and lower foot segments 38, 40 are also advantageously dimensioned to interlock to join multiple apparatuses 10 in side by side coupled relation. For example, each support foot unit 36 has specific dimensions and/or radii of curvature to facilitate interlocking with adjacent foot units 36 of an adjacent display apparatus 10 thereby defining the interlocked system 1 depicted in FIG. 1. In one embodiment, the lower foot segment 40 includes an outer surface 40o defining a radius of curvature which may be constant or varied. Similarly, the upper foot segment 38 has an inner surface 38i which defines a void 44. The inner surface 38i has a radius of curvature which may be constant or varied. In one embodiment, the radii of curvatures of each inner and outer surface 38i, 40o is varied to define generally corresponding elliptical arc segments. In particular, the radius of curvature of each of the inner surface 38i and the outer surface 40i is selected to provide an elliptical arc segment dimension of each the upper and lower foot segments 38, 40. The void 44 is also in the form of an elliptical arc segment and generally corresponds to the elliptical dimension of the arc segment of the lower foot segment 40. In one embodiment, the radii of curvature is selected such that the void 44 generally corresponds to, but, is slightly larger than (in length and height) the elliptical arc segment of the lower foot segment 40. With this arrangement, the lower foot segment 40 may be positioned within the void 44 of the upper foot segment 38 in overlapping manner. In one embodiment, the inner and outer surfaces 38i, 40o of the respective upper and lower foot segments 38, 40 may engage each other to couple the adjacent apparatuses 10 in side by side relation, i.e., the inner curved surface 38i of the upper foot segment 38 allows sufficient height and length to fit the lower foot segment 40 to nest inside the interior curve or void 44 of the upper foot segment 38. (see FIG. 1) Alternatively, the upper foot segment 38 may be positioned over the lower foot segment 40 with the lower foot segment 40 being received within the void 44.

Thus, the foot units 36 are advantageously dimensioned, through its respective heights, length and radii of curvature to interlock with other support feet units. In some embodiments, the display apparatus 10 may be positioned such that they are in contacting relation when overlapped. With this arrangement, the apparatuses 10 of the system 1 are interlocked with the display boards 12 in adjacent relation. In some embodiments, the display apparatuses 10 may be at an angle with respect to each other with the foot units 36 interlocked and the display boards 12 also at an angle. In other embodiments, the display apparatuses 10 may be generally longitudinally aligned.

As best depicted in FIG. 8, the inner side 36i of each support foot unit 36 includes a pair of spaced adhesive strips 46 extending along the length of the vertical mounting segment 42 for attachment to the respective support leg 22. The adhesive strips 46 may include a release cover as discussed hereinabove. The vertical mounting segment defines a width “mw”. In one embodiment, the width “mw” is substantially equal to the width “pw” (FIGS. 1 and 5) of the outer panel 30o of the support legs 22 to assist the subject in assembly and proper mounting of the support foot unit 36. Each support foot unit 36 is preferably monolithically formed of material sufficient to maintain the structure's 10 lightweight portability. In one embodiment, the support foot unit 36 is made of Duraplast®. Alternatively, the support foot unit 36 can be made of other materials, such as, for example, cardboard, foam board or Sintra®. Other features of the support foot unit 36 will be discussed in greater detail hereinbelow.

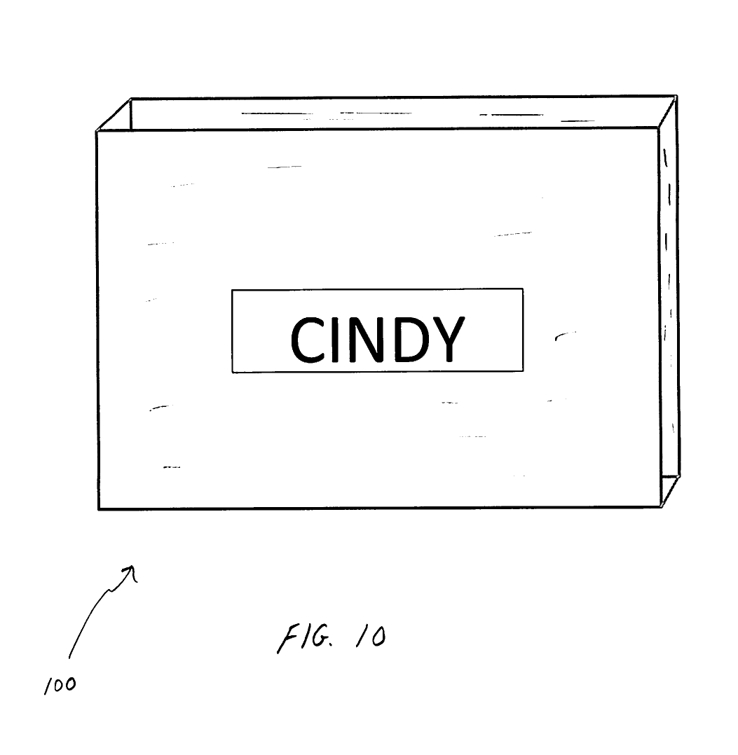

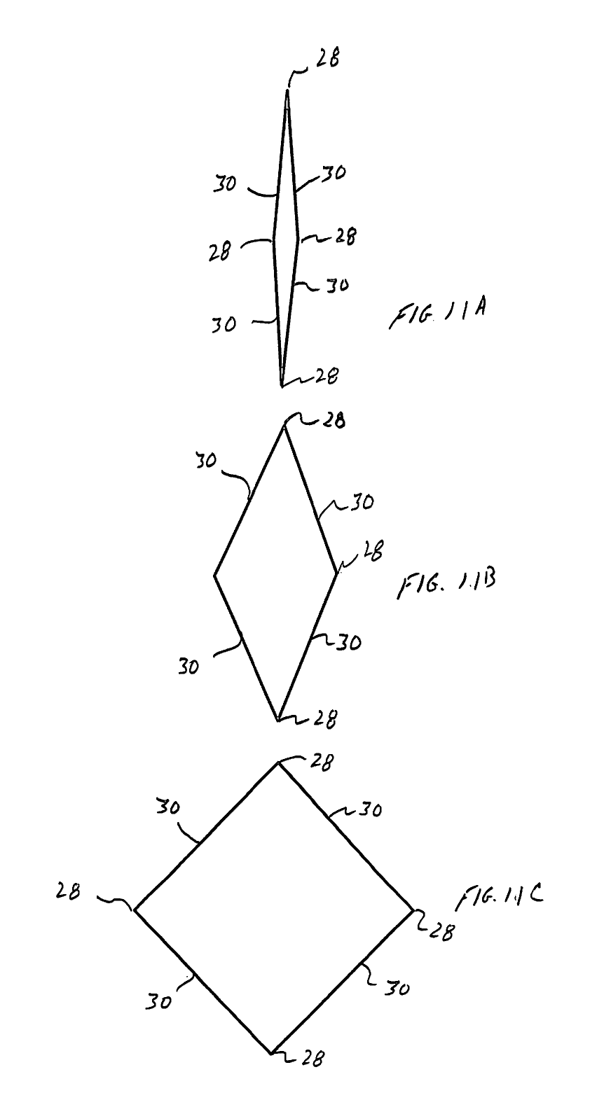

The delivery and assembly of one apparatus 10 will now be discussed. With reference to FIG. 10, each of the components of one apparatus 10 is packaged, in a flat state, in one single package 100 as represented by FIG. 10. The package, which is lightweight, low profile and portable may be carried by the subject to a presentation site, opened and the components of the apparatus 10 removed. As indicated hereinabove, the package includes two display boards 12, two support legs 22 and two support foot units 36. Due to the planar configuration of the components, the package 100 need only be slightly greater in height, width and depth than the display boards 12.

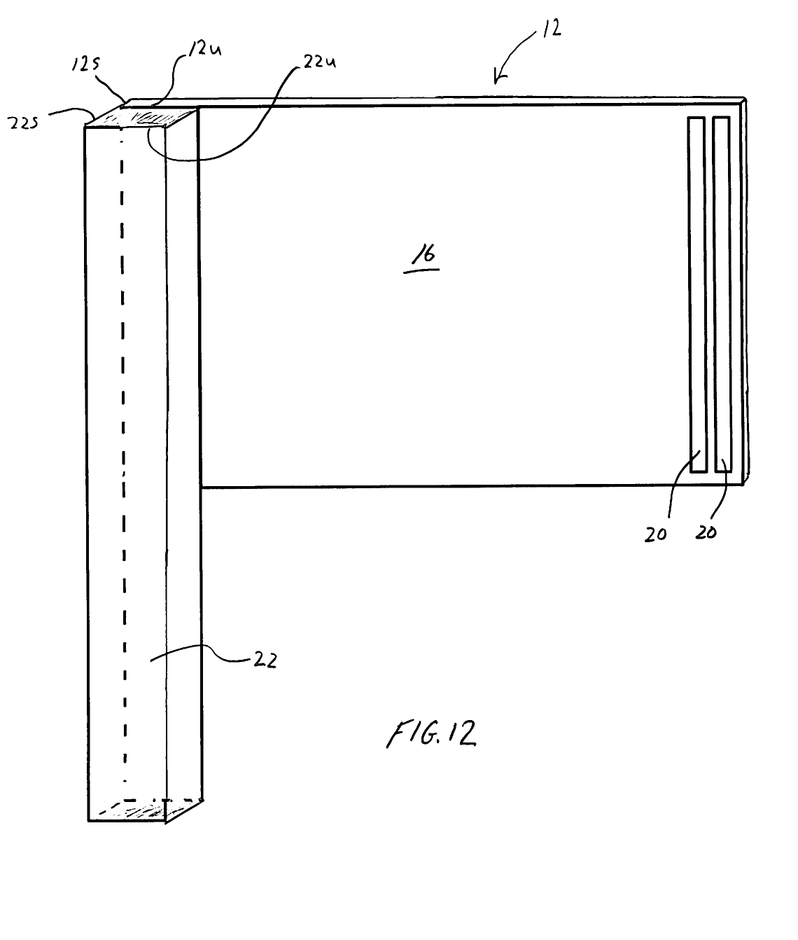

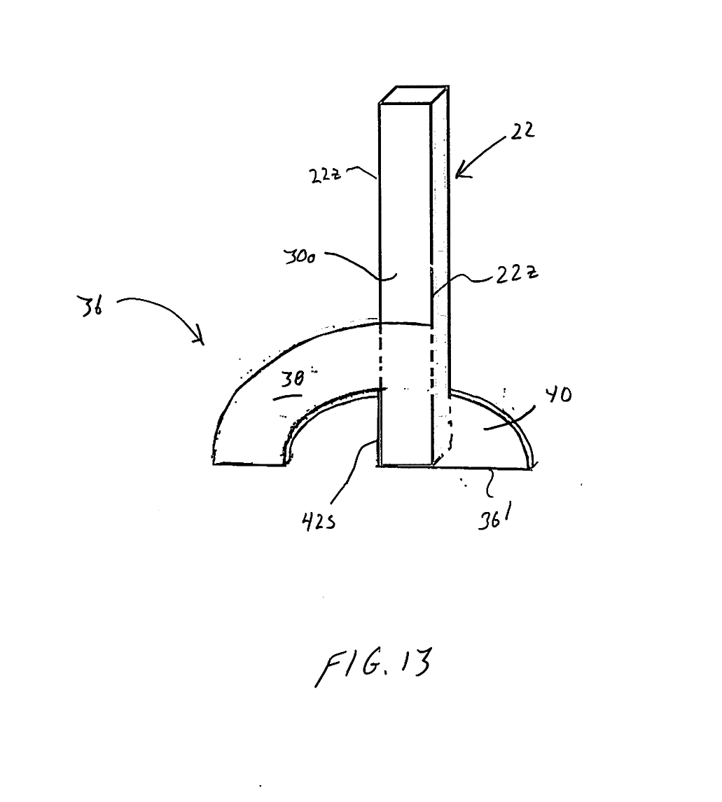

With reference to FIGS. 5 and 11A-11C, each support leg 22 is transitioned from its collapsed stored condition to the operative condition by folding the panels 30 of the support leg 22 along its fold lines 28. Once in the open condition of FIG. 11C, the flaps 32, 34 at each of the upper and lower ends of the support legs 22 are closed as discussed in connection with FIG. 6 thereby securing the support leg 22 in its open condition. Adhesive may be used if desired to secure the flaps 32, 34.

With reference to FIG. 12, the first display board 12 is manipulated to expose its rear side 18 (e.g. a side without coating). The backing layers are removed from the first pair of adhesive strips 20 to expose the adhesive. A first support leg 22 is positioned on the board such that the upper edge 22u of the support leg 22 is in alignment or coterminous with the upper edge 12e of the display board 12 and the side edge 22s of each support leg 22 is aligned or coterminous with the side edge 12s of the first display board 12. The support leg 22 is secured to the adhesive material. The process is repeated for the second support leg 22.

The positioning and arrangement of the pairs of adhesive strips 20 on the display board 12 guides the subject in proper placement and securement of the support leg 22 to the display board 12. Specifically, through the alignment of the upper and side edges 22u, 22s of the support leg 22 with the respective upper and side edges 12u, 12s of the display board 12 in conjunction with the positioning of the adhesive strips 20 confirmation is provided to the subject that the support leg 22 is properly assembled and positioned with respect to the board 12.

With both support legs 22 secured to the first board 12, the second board 12 is manipulated to expose the rear side 18 of the second board 12 (i.e., the side without the erasable coating). The backing layers of the adhesive strips 20 are removed and the support legs 22 are secured to the second display board 12 in a similar manner to that described above via aligning the upper and side edges 22u, 22s of the support leg 22 with the upper and side edges 12u,12s of the display board 12.

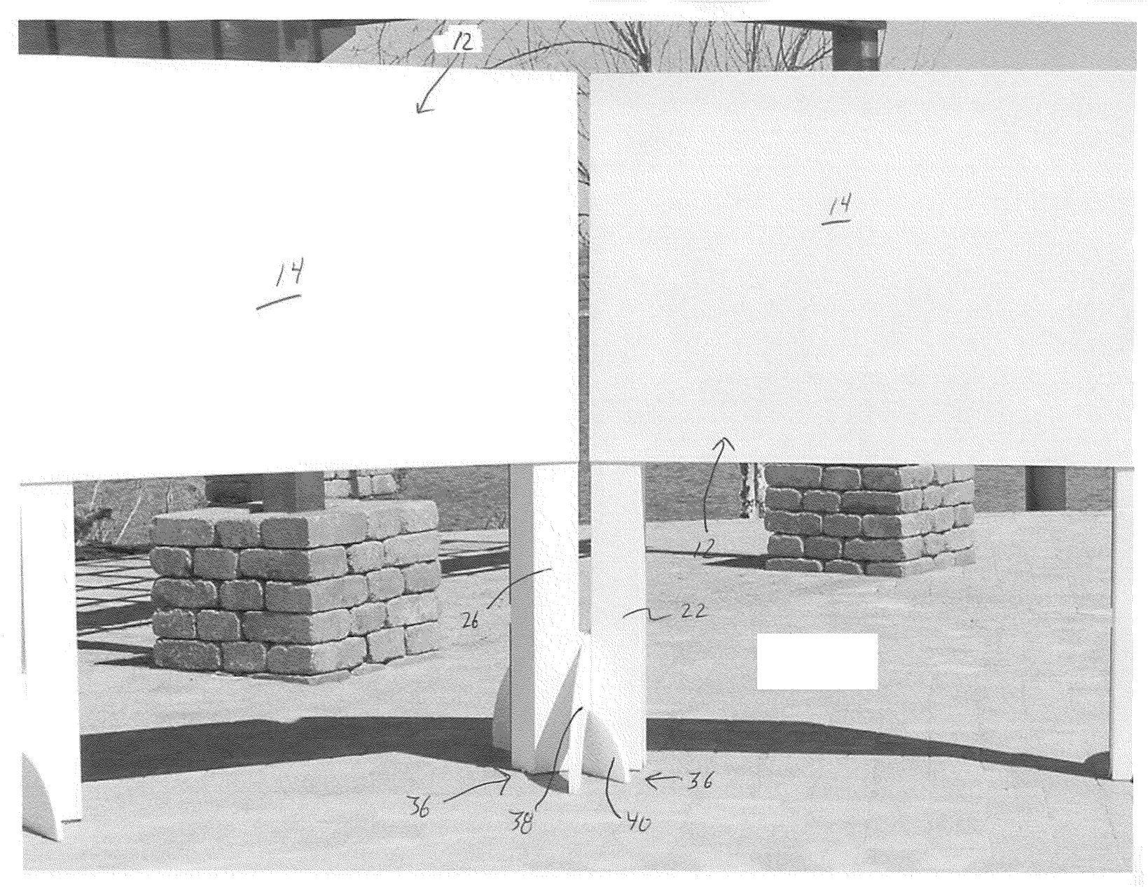

With the support legs 22 and the display boards 12 secured, attention is directed to securing the foot units 36. With reference to FIGS. 8 and 13, a first foot unit 36 is manipulated to expose its inner side 36i. The backing layers are removed and the vertical mounting segment 42 of the foot unit 36 is applied to the outer panel 30o of the support leg 22. The vertical mounting segment 42 defines a width which approximates or is substantially equal to the width of an outer panel 30o of the support leg 22 such that the subject need only align the side edges 42s of the mounting segment 42 with the edges 22z of the support leg 22, and the lower edge 361 of the foot unit 36 with the lower edge of the support leg 22. The process is continued for the second foot unit 36; however, the second foot unit 36 may be positioned in an opposite direction to the first foot unit 36. Specifically, the upper foot segment 38 of the first foot unit 36 may extend forward while the upper foot segment 38 of the second foot unit 36 extends rearward.

The apparatus 10, now assembled, may be used for brainstorming or a presentation. Both sides of the apparatus 10, i.e., both sides of the display boards 12 may be utilized during the presentation. If a second apparatus 10 is needed, the subject can assemble the second apparatus 10 in a similar manner. Thereafter, the foot units 36 of the adjacent display apparatuses 10 may be nested in the manner discussed hereinabove to couple the apparatuses 10 and provide the display system 1. FIGS. 1 and 14 illustrate a nested arrangement of the foot units 36 of adjacent apparatuses 10.

Subsequent to use, the display apparatuses may be disposed. In the alternative, due to the integrity of the structure of the apparatus, the apparatus may be reused.

Thus, the apparatus of the present disclosure provides a cost effective, portable display system (e.g. multi-paneled display) which can be easily and reliably assembled in a relatively short period of time. The apparatus is lightweight and disposable.

While the above description contains many specifics, these specifics should not be construed as limitations on the scope of the present disclosure, but merely as exemplifications of embodiments thereof. It is envisioned that the elements and features illustrated or described in connection with one exemplary embodiment may be combined with the elements and features of another exemplary embodiment without departing from the scope of the present disclosure, and that such modifications and variations are also intended to be included within the scope of the present disclosure. For example, the first and second foot segments of each foot unit may be individual components. Those skilled in the art will envision many other possible variations that are within the scope and spirit of the present disclosure.

What is claimed is:

1. A display system, which comprises:
at least one display apparatus, including:
a display board, the display board having a writable surface;
first and second support legs, the first and second support legs being adapted to convert from a first folded condition to a second at least partially open condition, the first and second support legs being attachable to the display board when in the second open condition thereof; and
first and second foot units for attaching to the respective first and second support legs.

2. The display system according to claim 1 including first and second display boards, each of the first and second display boards having the writable surface.

3. The display system according to claim 2 wherein the first and second support legs are configured for attachment to each of the first and second display boards such that the writable surface of each of the first and second display boards faces outwardly away from the first and second support legs.

4. The display system according to claim 1 wherein the first and second support legs each define a plurality of longitudinal panels separated by longitudinal fold lines extending substantially along respective lengths of the first and second support legs, the panels of the first and second support legs being foldable along the fold lines to assume the second open condition.

5. The display system according to claim 4 wherein the display board includes adhesive strips for attaching the first and second support legs to the display board.

6. The display system according to claim 5 wherein the display board includes two pairs of adhesive strips, a first pair being positioned adjacent a first edge of the display board for securing the first leg, a second pair being positioned adjacent a second side edge of the display board for securing the second leg.

7. The display system according to claim 5 wherein the first and second foot units each include a lower foot segment and an upper foot segment, the lower foot segment defining an outer curved surface and the upper foot segment defining a generally corresponding dimensioned inner curved surface.

8. The display system according to claim 7 wherein the first and second support legs unit each include an interconnecting segment disposed between the upper and lower foot segments, the interconnecting segments being attachable to the first and second support legs.

9. The display system according to claim 8 wherein each of the first and second foot units are substantially planar.

10. The display system according to claim 9 wherein the interconnecting segments of the first and second foot units include adhesive strips for attaching the first and second foot units to the first and second support legs.

11. The display system according to claim 10 wherein the interconnecting segments of the first and second foot units each define a width, the width approximating a corresponding width of a respective panel of the first and second support leg units to which the interconnecting segments are attached.

12. The display system according to claim 7 including first and second display apparatuses, the first and second display apparatuses positionable in side by side relation whereby the lower foot segment of one of the first and second foot units of the first display apparatus is positionable beneath the upper foot segment of one of the first and second foot units of the second display apparatus to couple the first and second display apparatuses.

13. The display system according to claim 5 including an outer package, the outer package storing the display board, the foot units and the first and second support legs in the folded condition.

14. A method for assembling a display apparatus, comprising:
providing a display apparatus including two display boards each having a writing surface, first and second support legs in a folded condition and first and second foot units;
transitioning the first and second support legs to an open condition by folding panels of each of the first and second support legs along respective fold lines;
mounting the first and second support legs when in the open condition to the first and second display boards; and
attaching the first and second foot units to the first and second support legs, respectively.

15. The method according to claim 16 including securing the first and second support legs in the open condition.

16. The method according to claim 15 wherein mounting the first and second support legs includes attaching the first and second support legs to adhesive strips of each of the first and second display boards.

17. The method according to claim 16 wherein attaching the first and second foot units includes securing the first and second support legs to adhesive strips of each of the first and second foot units.
